(19) United States
(12) Patent Application Publication
(10) Pub. No.: US 2026/0015468 A1
(43) Pub. Date: Jan. 15, 2026

(54) PROCESS FOR PREPARING A CO2-NEGATIVE POLYETHYLENE TEREPHTHALATE FROM RENEWABLE RAW MATERIALS

(71) Applicant: VOLKSWAGEN AKTIENGESELLSCHAFT, Wolfsburg (DE)

(72) Inventors: Armin Aniol, Braunschweig (DE); Fabian Fischer, Hannover (DE)

(21) Appl. No.: 18/995,628

(22) PCT Filed: Jun. 21, 2023
(86) PCT No.: PCT/EP2023/066890

§ 371 Date: Jan. 16, 2025

(30) Foreign Application Priority Data
Jul. 21, 2022 (DE) 10 2022 207 445.9

(51) Int. Cl. C08J 3/20; C08G 63/183; C25B 1/04; C25B 3/07

(52) U.S. Cl. CPC C08J 3/20; C08G 63/183; C25B 1/04; C25B 3/07; C08J 2301/02; C08J 2397/02

(57) ABSTRACT

A process for preparing a CO₂-negative polyethylene terephthalate (PET). The process includes: (a) obtaining monoethylene glycol (MEG) from a polysaccharide; (b) obtaining terephthalic acid (PTA) from a polysaccharide; and (c) reacting the monoethylene glycol obtained in step (a) with the terephthalic acid obtained in step (b) to form polyethylene terephthalate. The process utilizes polysaccharides, which can be derived from renewable sources, and may achieve a CO₂-negative balance in certain examples.

### RELATED APPLICATIONS

The present application claims priority to International Patent Application No. PCT/EP2023/066890 to Armin Aniol and Fabian Fischer, filed Jun. 21, 2023, titled “Process For Preparing A Co₂-Negative Polyethylene Terephthalate From Renewable Raw Materials,” which claims priority to German Patent Application No. 10 2022 207 445.9, filed Jul. 21, 2022, the contents of each being incorporated by reference in their entirety herein.

### TECHNICAL FIELD

The present disclosure relates to the production of CO₂-negative polyethylene terephthalate.

### BACKGROUND

The use of sustainable materials provides effective leverage when it comes to improving the overall CO₂ balance, for example of vehicles. In this context, sustainable polymer solutions are becoming increasingly more important in the automotive industry. The three most relevant raw material sources for sustainable polymers encompass biobased approaches based on renewable raw materials, plastic recyclates, and CO₂-based polymer approaches. Biobased polymers are already known in literature (PLA, PHB and the like) to keep the CO₂ footprint low over the entire product life cycle compared to the petrochemical alternative. Additionally, thermoplastic polymers from recyclate processes are increasingly being used to minimize CO₂ emissions through a closed material loop. These two major parts of the aforementioned material classes, however, are less suitable for use in sophisticated applications since neither the molecular weight nor the molecular weight distribution can be controlled with the biobased approaches and the plastic recyclates due to natural synthesis processes and degradation effects during the recycling process.

It is known that the polymer polyethylene terephthalate (PET) can be produced from monoethylene glycol (MEG) and purified terephthalic acid (PTA). The terephthalic acid can be synthesized by way of the intermediate stages chloromethylfurfural (CMF), methylfurfural (MF), dimethylfurfural (DMF), and p-xylene.

The catalytic synthesis of monoethylene glycol (MEG) from CO₂ is known from US 2020/0347502 A1, for example.

Frequently, MEG is also obtained from the epoxide ethylene oxide.

The synthesis of PTA (terephthalic acid) from renewable resources, such as cellulose, via the stage of para-xylene is known from U.S. Pat. No. 8,889,938 B2.

US 2011/0311829 A1 also relates to renewable resources. A method is described for the CO₂ emissions-neutral production of pressure-stable and tension-stable building materials and fibers. The second step is even reported as being CO₂ emissions-negative. Synthetic carbon fibers replace concrete or steel.

### SUMMARY

Aspects of the present disclosure are directed to providing a more environmentally friendly production process for polyethylene terephthalates. In some examples, the process should have a CO₂-negative balance, and/or the molecular weight distribution should be narrow. This means that it should be possible for the polymerization process to take place in a controlled manner. Moreover, the polyethylene terephthalate should be stable.

In some examples, a process is disclosed for producing a CO₂-negative polyethylene terephthalate (PET) comprising:
a) obtaining monoethylene glycol (MEG) from a polysaccharide;
b) obtaining terephthalic acid (PTA) from a polysaccharide, which can be identical to or different from the polysaccharide from step a); and
c) reacting the monoethylene glycol (MEG) from step a) with the terephthalic acid (PTA) from step b) to form polyethylene terephthalate (PET).

The order of steps a) and b) can obviously also be reversed.

Further aspects of the present disclosure are provided in the description, drawings and claims provided herein.

Various aspects of the present disclosure can advantageously be combined with one another, unless indicated otherwise in the specific instance.

### BRIEF DESCRIPTION OF THE DRAWINGS

Aspects of the present disclosure will be described hereafter in exemplary embodiments based on the associated drawings.

FIG. 1 shows a specific exemplary embodiment of the process according to some aspects of the present disclosure.

### DETAILED DESCRIPTION

Polysaccharides, also referred to as polysugars, multi-sugars, glycans, or polyoses, are carbohydrates composed of a large number of monosaccharides (at least 11) joined through glycosidic bonds. Examples of polysaccharides include glycogen, starch (amylose and amylopectin), pectins, chitin, callose, and cellulose. Polysaccharides are also present in wood, where they exist as cellulose and hemicellulose in combination with lignin. According to the present disclosure, the term “polysaccharide” encompasses mixtures of different polysaccharides.

The synthesis of polyethylene terephthalate (PET) from monoethylene glycol (MEG) and terephthalic acid (PTA) occurs via esterification catalysis. The industrial synthesis of CO₂-negative polyethylene terephthalate described herein involves either a two-stage direct polycondensation reaction or mass polymerization. The polymerization reaction uses MEG, PTA, and esterification catalysts as starting materials. Initially, PTA reacts with excess MEG to form oligoester structures, while water is removed to shift the equilibrium toward the reaction products. Esterification catalysts maintain a consistent reaction rate by activating the catalytically active acid groups. To increase the molecular weight of the polymer, subsequent mass polymerization can be conducted industrially, wherein stoichiometric proportions of the monomers are used instead of excess MEG. The reaction is conducted within the temperature range between the glass transition and melting temperatures of the polymer material to ensure the mobility of forming chain segments. This process produces polymers with molar masses exceeding 100,000 Da and high crystallinity.

The present disclosure also relates to the use of polysaccharides in processes for producing CO₂-negative polyethylene terephthalate (PET), including the processes described herein. Preferred embodiments apply to both the processes and the resulting uses of the PET produced. The described production process and the resulting polymer are CO₂-negative, as CO₂ is chemically bound during synthesis. This ecological process uses renewable raw material sources. By contrast, prior art processes for PET production are CO₂-neutral, as at least one starting material, typically MEG or PTA, is derived from petroleum. The CO₂-based polymer synthesis described herein achieves a narrow molecular weight distribution, and the resultant PET is comparable to, or better than, petroleum-based polymers in terms of properties.

The PET produced is suitable for numerous applications, including vehicle construction, continuous filaments, staple fibers, crimped fibers, and felts or tows for apparel fabrics, home textiles, and industrial uses. Additional applications include mixtures with other fibers such as cotton, wool, silk, or synthetic fibers, as well as floor coverings and technical uses such as conveyor belts, drive belts, tire cords, firefighting hoses, ropes, filter materials, sewing threads, and yarns. Further uses include gas-tight films or bottles for the food industry, as well as applications in equipment construction, precision engineering, household appliances, photo films, magnetic tapes, food packaging, and other related industries.

In one preferred embodiment, the polysaccharide is sourced from agricultural or industrial plant waste, including pulp products, sawdust, wood shavings, or wood. Steps (a) or (b) of the process may include additional extraction or comminution steps. In another preferred embodiment, at least one polysaccharide from steps (a) and (b) is selected from cellulose, including cellulose residues such as wood chips, wood shavings, sawdust, wood waste, or waste paper. The same polysaccharide source is preferably used in both steps (a) and (b), simplifying industrial implementation and improving process efficiency. When cellulose, including cellulose residues, is used as the polysaccharide in both steps (a) and (b), the process becomes less expensive because cellulose is commonly available as waste from other industrial processes and serves as an ecological alternative to petroleum-based starting materials.

In another preferred embodiment, the polysaccharide is thermally degraded in step (a) and converted into ethylene, CO₂, and H₂O, ensuring complete utilization of the polysaccharide. Ethylene, CO₂, and H₂O serve as relevant raw materials for various reactions. The thermal degradation process is conducted at temperatures exceeding 300° C., with preferred ranges between 350° C. and 500° C., particularly between 350° C. and 450° C.

In a preferred variation of this embodiment, the thermal degradation product is converted into ethylene, CO₂, and H₂O using Fischer-Tropsch synthesis, which is advantageous for obtaining these products with high purity. Another variation involves reacting CO₂ and H₂O electrolytically to produce monoethylene glycol (MEG), O₂, and H₂. The MEG produced serves as a starting material for PET synthesis, while O₂ and H₂ can be used in subsequent steps, such as obtaining PTA. The energy and CO₂ balances of the process are notably improved by utilizing O₂ and H₂ in step (b).

These variations can be combined. For example, ethylene produced in step (a) can be utilized in step (b) to synthesize PTA, including intermediates such as p-xylene. Using ethylene derived from polysaccharides enhances the energy and CO₂ balances of the process. Additionally, O₂ and H₂ obtained in step (a) can be used in step (b) to synthesize PTA, such as using H₂ for methylfurfural synthesis from chloromethylfurfural or O₂ for synthesizing PTA from p-xylene. Utilizing O₂ and H₂ further improves the energy and CO₂ balances.

In another preferred embodiment, the reaction in step (c) is conducted at temperatures between 260° C. and 290° C., particularly between 270° C. and 280° C., to enhance the solubility of PTA in MEG. Improved solubility ensures an adequate monomer supply for the reaction. The pressure in step (c) is maintained at or below 50 Pa, with a preferred range of 10 Pa to 50 Pa, ensuring optimal reaction conditions.

### Exemplary Embodiment 1

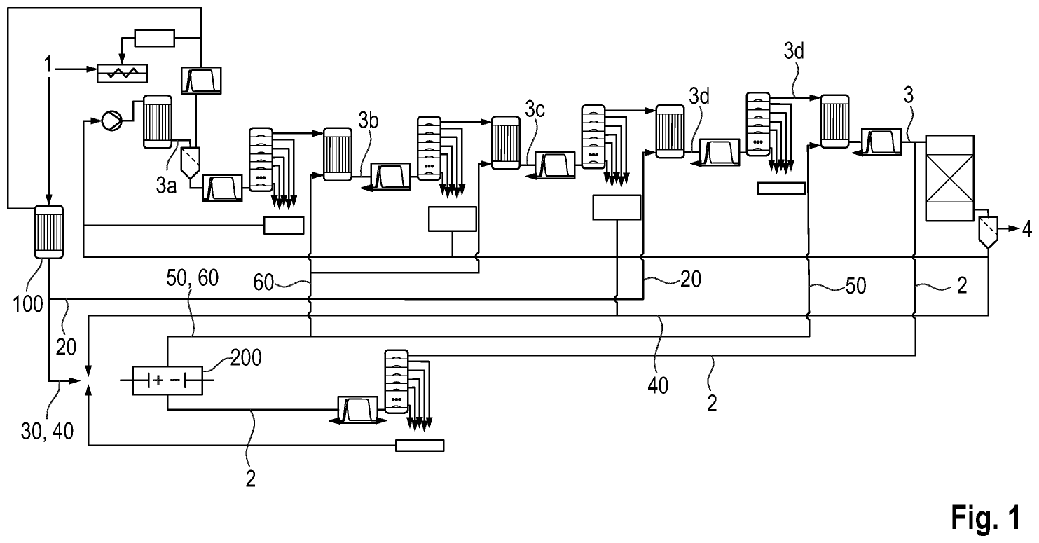

FIG. 1 shows the specific exemplary embodiment 1. The temperature during the reaction of MEG and PTA (in step c) is 270-280° C., and the pressure is <50 Pa.

FIG. 1 illustrates a process for producing polyethylene terephthalate (PET) from polysaccharides. The polysaccharide (1) undergoes thermal degradation in step 100, where it is converted into ethylene (20), carbon dioxide (30), and water (40). The carbon dioxide and water are routed to step 200, where electrolysis produces monoethylene glycol (2), oxygen (50), and hydrogen (60). The ethylene, oxygen, and hydrogen generated are introduced into subsequent reaction stages for the synthesis of terephthalic acid (3) through a series of intermediates, including chloromethylfurfural (3a), methylfurfural (3b), dimethylfurfural (3c), and p-xylene (3d). The PTA (3) produced is combined with monoethylene glycol (2) to form polyethylene terephthalate (4) under the conditions described for step (c). The process integrates outputs from the thermal degradation and electrolysis stages into the production of PTA, thereby achieving an energy-efficient and CO₂-negative synthesis.

In some examples, the thermal degradation in step 100 may be conducted under conditions that facilitate the breakdown of polysaccharides into ethylene (20), carbon dioxide (30), and water (40), as described herein. The degradation typically occurs at temperatures between 350° C. and 500° C., which are well-suited for producing gaseous products. The Fischer-Tropsch synthesis converts these products into ethylene using catalysts and conditions known to those skilled in the art. In step 200, CO₂ and H₂O are electrolytically converted to monoethylene glycol (2), oxygen (50), and hydrogen (60) under standard electrolysis conditions, such as those utilizing appropriate electrode materials and voltage ranges. The ethylene, oxygen, and hydrogen are introduced into subsequent reaction stages for the synthesis of terephthalic acid (3) via the intermediates chloromethylfurfural (3a), methylfurfural (3b), dimethylfurfural (3c), and p-xylene (3d), using catalysts and conditions as understood by those skilled in the art. These steps ensure energy efficiency and a CO₂-negative balance throughout the process.

In the example of FIG. 1, waste was used as the polysaccharide source for producing the PTA, wherein it was first converted to chloromethylfurfural.

Additionally, the cellulose waste was thermally decomposed and, using the Fischer-Tropsch method, was converted to ethylene (=ethene), carbon dioxide, and water, wherein the latter two substances were electrolytically refined to oxygen, hydrogen, and MEG.

As is apparent from FIG. 1, ethylene as well as oxygen and hydrogen were introduced into the PTA synthesis and used there for various reaction stages (in the production of PTA via CMF, MF, DMF and p-xylene).

### LIST OF REFERENCE NUMERALS

1 polysaccharide
2 monoethylene glycol (MEG)
3 terephthalic acid (PTA, purified terephthalic acid)
4 polyethylene terephthalate (PET)
3a chloromethylfurfural (CMF)
3b methylfurfural (MF)
3c dimethylfurfural (DMF)
3d p-xylene
20 ethylene (ethene)
30 CO₂
40 H₂O
50 O₂
60 H₂
100 thermal degradation of the polysaccharide and Fischer-Tropsch method
200 electrolysis of the CO₂ and of the H₂O to MEG, O₂ and H₂

1-10. (canceled)

11. A process for producing a CO₂-negative polyethylene terephthalate (PET), comprising:
a) obtaining monoethylene glycol (MEG) from a polysaccharide;
b) obtaining terephthalic acid (PTA) from a polysaccharide, wherein the polysaccharide in step (b) is either identical to or different from the polysaccharide in step (a); and
c) reacting the monoethylene glycol obtained in step (a) with the terephthalic acid obtained in step (b) to form polyethylene terephthalate (PET).

12. The process of claim 11, wherein each polysaccharide in steps (a) and (b) is derived from renewable resources.

13. The process of claim 11, wherein at least one polysaccharide in steps (a) or (b) is selected from the group consisting of wood and cellulose.

14. The process of claim 12, wherein at least one polysaccharide in steps (a) and (b) is selected from the group consisting of wood and cellulose.

15. The process of claim 13, wherein the same polysaccharide is used in both steps (a) and (b) and is selected from the group consisting of wood and cellulose.

16. The process of claim 11, wherein the polysaccharide in step (a) is thermally degraded and converted into ethylene, carbon dioxide, and water.

17. The process of claim 16, wherein thermal degradation in step (a) is performed using Fischer-Tropsch synthesis to convert the degraded polysaccharide into ethylene, carbon dioxide, and water.

18. The process of claim 17, wherein carbon dioxide and water produced from the thermal degradation in step (a) are electrolytically converted into monoethylene glycol, oxygen, and hydrogen.

19. The process of claim 18, wherein ethylene obtained from the thermal degradation in step (a) is used in step (b) for obtaining terephthalic acid.

20. The process of claim 18, wherein oxygen and hydrogen obtained during the electrolysis in step 18 are used in step (b) for obtaining terephthalic acid.

21. A method for utilizing polysaccharides in producing a CO2-negative polyethylene terephthalate (PET), comprising:
a) obtaining monoethylene glycol (MEG) from a polysaccharide, wherein the polysaccharide is thermally degraded to produce ethylene, carbon dioxide, and water;
b) obtaining terephthalic acid (PTA) from a polysaccharide, wherein the polysaccharide is converted through a series of intermediates, including chloromethylfurfural (CMF), methylfurfural (MF), dimethylfurfural (DMF), and p-xylene; and
c) reacting the monoethylene glycol obtained in step (a) with the terephthalic acid obtained in step (b) to form polyethylene terephthalate (PET).

22. The method of claim 21, wherein each polysaccharide in steps (a) and (b) is derived from renewable resources.

23. The method of claim 21, wherein at least one polysaccharide in steps (a) or (b) is selected from the group consisting of wood and cellulose.

24. The method of claim 22, wherein at least one polysaccharide in steps (a) and (b) is selected from the group consisting of wood and cellulose.

25. The method of claim 23, wherein the same polysaccharide is used in both steps (a) and (b) and is selected from the group consisting of wood and cellulose.

26. The method of claim 21, wherein the polysaccharide in step (a) is thermally degraded using Fischer-Tropsch synthesis to convert the polysaccharide into ethylene, carbon dioxide, and water.

27. The method of claim 26, wherein carbon dioxide and water produced from the thermal degradation in step (a) are electrolytically converted into monoethylene glycol, oxygen, and hydrogen.

28. The method of claim 27, wherein ethylene obtained from the thermal degradation in step (a) is used in step (b) for obtaining terephthalic acid.

29. The method of claim 27, wherein oxygen and hydrogen obtained during the electrolysis in step (a) are used in step (b) for obtaining terephthalic acid.

30. The method of claim 21, wherein the reaction in step (c) is conducted at a temperature between 270° C. and 280° C. and at a pressure of less than 50 Pa to enhance the solubility of terephthalic acid in monoethylene glycol.
